(19) United States
(12) Patent Application Publication
(10) Pub. No.: US 2024/0279113 A1
(43) Pub. Date: Aug. 22, 2024

(54) A SCALABLE AND SUSTAINABLE PROCESS FOR TRANSFORMING INCINERATION BOTTOM ASH INTO USEABLE AGGREGATES

(71) Applicant: ENGRO CORPORATION LIMITED, Singapore (SG)

(72) Inventors: Chee Keong GOH, Singapore (SG); Lok Hing TANG, Singapore (SG); Soorya Prakash -, Singapore (SG); Sui Shong LOH, Singapore (SG); Eik Shuan TAN, Singapore (SG)

(21) Appl. No.: 18/293,387

(22) PCT Filed: Jul. 29, 2022
(86) PCT No.: PCT/SG2022/050542

§ 371 Date: Jan. 30, 2024

(30) Foreign Application Priority Data
Jul. 30, 2021 (SG) 10202108358Q

(51) Int. Cl. C04B 18/02; C04B 28/08; C04B 40/02

(52) U.S. Cl. CPC C04B 18/021; C04B 28/08; C04B 40/0281

(57) ABSTRACT

Herein disclosed is an aggregate comprising a cement comprising ordinary Portland cement, a ground granulated blast-furnace slag, and bottom ash, wherein the cement is hydrated in the presence of the ground granulated blast-furnace slag to have a calcium silicate hydrate or derivative thereof formed which encapsulate the bottom ash. A method of producing the aggregate is disclosed herein also, the method comprising mixing the cement and the ground granulated blast-furnace slag with the bottom ash in the presence of water to form pre-coated bottom ash, and granulating the pre-coated bottom ash.

### CROSS-REFERENCE TO RELATED APPLICATION

This application claims the benefit of priority of Singapore patent application No. 10202108358Q, filed 30 Jul. 2021, the content of it being hereby incorporated by reference in its entirety for all purposes.

### TECHNICAL FIELD

The present disclosure relates to an aggregate. The present disclosure also relates to a method of producing the aggregate and uses of the aggregate.

### BACKGROUND

The rate at which municipal solid waste (MSW) is generated may be increasing, perhaps proportionately, with the growth of global population on anthropogenic activities, urbanisation, economic developments, and industrialisation. Landfill and incineration may be deemed two main MSW treatment/disposal approaches around the world. Thus, increasing MSW may unavoidably raise the pressure to have more landfill for disposing incineration residue. Referring to Singapore as an example, in 2019 alone, about 7.2 million tonnes of MSW was estimated to be generated, among them 58% was estimated to have been recycled, 39% was estimated to have been incinerated, and 3% was estimated to have been landfilled. Although 90% by volume of waste may be reduced through incineration, it is still not the final stage of waste treatment at the end of incineration. This is because the residues, such as incineration bottom ash (IBA) and incineration fly ash (IFA), still need to be disposed off after incineration by landfill and there is only one landfill in Singapore, which is Semakau landfill (SL). Unfortunately, the lifespan of SL is expected to last for less than 20 years up to 2035. Thus, countries, such as Singapore, may have to exercise careful planning on fully utilizing the incineration ash (IA), especially incineration bottom ash which accounts for 85%-95% of the total weight of ash after the MSW incineration, which appears the only way to prolong the lifespan of SL due to limited landfill availability.

To reduce incineration bottom ash for disposal in landfills, uses for incineration bottom ash were explored. However, toxic heavy metals and chloride content in incineration bottom ash seems to significantly hinder its utilization in numerous applications. Therefore, even before incineration bottom ash may be utilized, it has to be treated. Many existing treatment methods such as separation process for metal recovery, solidification/stabilization to immobilize the hazardous content in the incineration bottom ash, thermal treatments, and alkaline treatments, may have improved the quality of incineration bottom ash and reduce environmental impact. Despite this, such treatment processes tend to be either time consuming, costly, or challenging in practice. For instance, the use of chemicals and recirculating the same water to wash IBA may often lead to increased amount of heavy metals dissolved in the water, reaching concentrations that exceed effluent regulation limits.

To utilize incineration bottom ash while minimizing or avoiding aforesaid treatments, the use of MSW incineration bottom ash as a coarse or fine aggregate replacement in concrete was explored given the source for non-renewable natural aggregates are depleting rapidly as global demand continues to increase. In general, incineration bottom ash may contain metallic, ceramic, stone, glass fragments and unburnt organic matter, with particles size distribution probably ranging from 0.1 mm to 100 mm. Stone fragments made of incineration bottom ash has been among the most sought alternative aggregate material. This may be because incineration bottom ash stone fragment may be similar to an aggregate and the large incineration bottom ash quantity generated by waste-to-energy plants makes incineration bottom ash stone fragment a convenient alternative for bridging the aggregate demand-supply gap. That said, incineration bottom ash stone fragments tend to contain high concentrations of toxic heavy metals which may leach out easily and may have relatively weaker strength properties like that of untreated incineration bottom ash as compared to treated incineration bottom ash. Hence, it remains a challenge to use untreated IBA as aggregates replacement in concrete.

There is therefore a need for scalable, sustainable, and cost-effective treatment method for converting IBA into usable materials, such as coarse or fine aggregates in the production of ready-mixed concrete.

### SUMMARY

In a first aspect, there is provided for an aggregate comprising:
a cement comprising ordinary Portland cement;
a ground granulated blast-furnace slag; and
bottom ash,
wherein the cement is hydrated in the presence of the ground granulated blast-furnace slag to have a calcium silicate hydrate or derivative thereof formed which encapsulates the bottom ash.

In another aspect, there is provided a method of producing the aggregate as described in various embodiments of the first aspect, the method comprising:
mixing the cement and the ground granulated blast-furnace slag with the bottom ash in the presence of water to form pre-coated bottom ash; and
granulating the pre-coated bottom ash.

### BRIEF DESCRIPTION OF THE DRAWINGS

The drawings are not necessarily to scale, emphasis instead generally being placed upon illustrating the principles of the present disclosure. In the following description, various embodiments of the present disclosure are described with reference to the following drawings, in which:

FIG. 1A shows a cross-section of one of the GGBS-OPC coated IBA aggregates (which may be denoted herein GGBS-coated IBA aggregates) of the present disclosure (see left image, which is an optical image obtained via optical microscopy). The aggregate was cut through its center. The average size of the aggregate is 2418.78 μm. This aggregate is based on a GGBS-OPC:IBA weight ratio of 2:1. The average thickness of the encapsulation layer surrounding the IBA core is 448.31 μm, which is derived from at least 18 points (e.g. 18 or 20 points) measured along the encapsulation layer as indicated in the table (see right image). The average size of the aggregates may range from 2000 μm to 4000 μm, 2418 μm to 2523 μm, etc. The average thickness of the encapsulation layer surrounding the IBA core may range from 295 μm to 449 μm, 319 μm to 449 μm, etc.

FIG. 1B shows a cross-section of another one of the GGBS-OPC coated IBA aggregates of the present disclosure (see left image, which is an optical image obtained via optical microscopy). The aggregate was cut through its center. The average size of the aggregate is 2523.072 μm. This aggregate is based on a GGBS-OPC:IBA weight ratio of 1:1. The average thickness of the encapsulation layer surrounding the IBA core is 319.118 μm, which is derived from 20 points measured along the encapsulation layer as indicated in the table (see right image). The average size of the aggregates may range from 2000 μm to 4000 μm, 2418 μm to 2523 μm, etc. The average thickness of the encapsulation layer surrounding the IBA core may range from 295 μm to 449 μm, 319 μm to 449 μm, etc.

FIG. 2 shows a brief illustration of a method of the present disclosure. In the illustrated method, the IBA (which may have a size of 0.3 mm to 2 mm, 1.12 mm to 2 mm, etc.) was first wetted with water by spraying water onto the IBA particles. A powder mixture containing ground granulated blast-furnace slag (GGBS) and ordinary Portland cement (OPC) are then mixed with the wetted IBA particles, which are then subject to granulation to form GGBS-OPC coated IBA aggregates. As can be seen in FIG. 2, the GGBS-OPC coated IBA aggregates are depicted in the form of core-shell aggregates. The shell contains the GGBS-OPC, which may be converted entirely or substantially into calcium silicate hydrate (C—S—H). The core contains the IBA, having the heavy metals and toxic materials confined therein and prevented from leaching out by the shell layer.

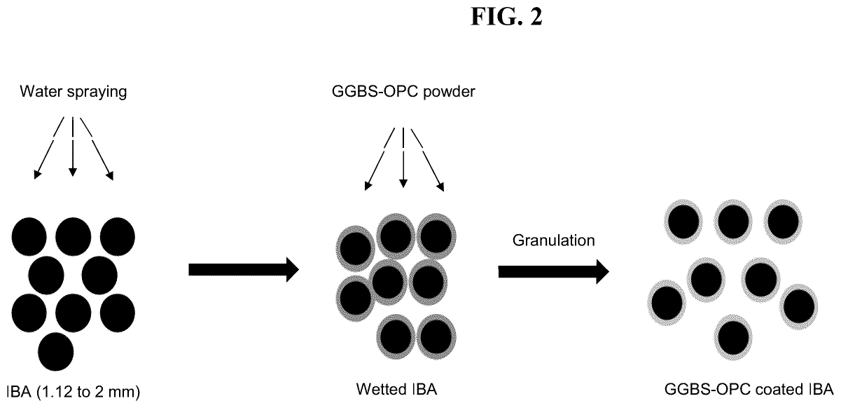

FIG. 3A is a table showing the results of a batch leaching test based on a standard of EN 12457-1:2002 (in mg/kg) for samples denoted CS0 to CS15. The batch leaching tests detect for heavy metals and certain toxic elements and compounds. including chemical oxygen demand (COD). The aggregates in this sample are based on a GGBS-OPC:IBA weight ratio of 2:1.

FIG. 3B is a table showing the results of a batch leaching test based on a standard of EN 12457-1:2002 (in mg/kg) for samples denoted CS11-R. The batch leaching tests detect for heavy metals and certain toxic elements and compounds, including chemical oxygen demand (COD). The aggregates in this sample are based on a GGBS-OPC:IBA weight ratio of 1:1. 14D and 7D denote for the number of days of curing (14 days and 7 days, respectively) the samples undergone.

FIG. 4 is a table showing the results of a leaching test for various volatile organic components (in mg/kg) for samples CS0 to CS15.

FIG. 5 shows a flow chart of one embodiment of the method of the present disclosure. Particularly, in this embodiment, the raw IBA may undergo sieving and/or a size reduction step. The IBA may then be wetted with water prior to mixing with GGBS and OPC to form a GGBS-OPC coated IBA aggregate. The GGBS-OPC coated IBA aggregate may undergo curing.

FIG. 6 shows a flow chart of another embodiment of the method of the present disclosure. Particularly, this embodiment differs from that illustrated in FIG. 5 in that a cement slurry is first formed by mixing GGBS and OPC with water, then the cement slurry containing the GGBS and OPC is mixed with IBA.

### DETAILED DESCRIPTION

The following detailed description refers to the accompanying drawings that show, by way of illustration, specific details and embodiments in which the present disclosure may be practised.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The present disclosure relates to an aggregate. The aggregate of the present disclosure may be termed herein a “manufactured aggregate”, which includes reference to an aggregate usable in concrete and the aggregate is a particulate material, wherein the particulate material can be a composite (i.e. a mixture of materials). The present aggregate can be used in various applications, including and not limited to, as a building and/or construction materials, for coastal applications, as a support material, etc.

The aggregate can be incorporated into concrete as an environmental friendly replacement for traditional aggregates. The present aggregate is advantageous in that it is derived from waste materials. Hence, the present aggregate is not only cost-effective, but also reduces the amount of waste materials to be disposed. For example, the present aggregate can be formed from bottom ash, e.g. incineration bottom ash (IBA), which is traditionally disposed in landfills. In countries with limited land, such as Singapore, this is a concern. Therefore, utilizing incineration bottom ash reduces the amount disposed in landfills, thereby sustaining the lifespan of landfills. Also, the present aggregate may be formed using granulated blast-furnace slag (GBS), which is an unwanted by-product from production of steel. As such, the present aggregate is environmentally advantageous in reducing IBA waste disposal and recycling of unwanted GBS by-product.

As mentioned above, the present aggregate can be used in various applications, including and not limited to, as a building and/or construction material, for coastal applications, as a support material, etc., even when the present aggregate contains IBA, wherein the IBA may contain heavy metals and toxic substances harmful to the environment. This is because the present aggregate has a core-shell structure, wherein the shell encapsulates the IBA in the core and the shell confines the heavy metals and toxic substances in the core, preventing them from leaching out.

The present disclosure also relates to a method of producing aforesaid aggregate. The present method is straightforward as compared to traditional methods of producing a concrete aggregate and does not require prior chemical treatment of the IBA. The present method may involve grinding of raw IBA to reduce its original size and granulation of the IBA with a powder binder (i.e. a powder mixture) formed of ground granulated blast-furnace slag (GGBS) and ordinary Portland cement (OPC), i.e. GGBS-OPC (also abbreviated as OPC-GGBS). Ground granulated blast-furnace slag refers to grounded granulated blast-furnace slag.

Details of various embodiments of the present aggregate and method, and advantages associated with the various embodiments are now described below. Where the embodiments and advantages have been described in the examples section further herein below, they shall not be reiterated for brevity.

In various embodiments, the aggregate can comprise a cement, a ground granulated blast-furnace slag, and bottom ash. The cement can comprise ordinary Portland cement. The ground granulated blast-furnace slag can comprise microfine ground granulated blast-furnace slag. The cement and the ground granulated blast-furnace slag can comprise a calcium silicate hydrate or derivative thereof which encapsulates the bottom ash. In other words, the cement can be hydrated in the presence of the ground granulated blast-furnace slag to have a calcium silicate hydrate or derivative thereof formed which encapsulates the bottom ash.

The term “cement” refers to an ingredient of concrete, wherein the cement can act as a binder, i.e. a substance used for construction that sets, hardens, and/or adheres to other materials (sand, gravel, etc.) to bind them together. The cement of the present disclosure can include or consist of a hydraulic cement.

In various embodiments, the present cement may be a hydraulic cement. A hydraulic cement refers to a cement that becomes adhesive and sets due to a chemical reaction between (i) dry ingredients used in the cement and/or concrete and (ii) water. The chemical reaction results in mineral hydrates that are considerably water-insoluble, which confers durability in water and resistance against chemical attack. Also, a hydraulic cement can set in wet conditions or under water, and further protects the hardened material from chemical attack. A non-limiting example of a hydraulic cement includes or can be Portland cement.

The terms “Portland cement” and “ordinary Portland Cement” are interchangeably used herein. Ordinary Portland cement is abbreviated OPC in the present disclosure. The term “Portland cement” is not a brand name, but a generic term for a type of cement; just as stainless steel is a type of steel. A Portland cement can include, but is not limited, tricalcium silicate (3CaO·SiO₂), dicalcium silicate (2CaO·SiO₂), tricalcium aluminate (3CaO·Al₂O₃), and/or a tetra-calcium aluminoferrite (4CaO·Al₂O₃Fe₂O₃).

In various embodiments, the ordinary Portland cement may comprise microfine ordinary Portland cement. In various embodiments, the ordinary Portland cement may comprise lime (CaO), silica (SiO₂), alumina (Al₂O₃), iron (III) oxide (Fe₂O₃), and/or magnesia (MgO). In various embodiments, the microfine ordinary Portland cement may comprise lime (CaO), silica (SiO₂), alumina (Al₂O₃), iron (III) oxide (Fe₂O₃), and/or magnesia (MgO).

In various embodiments, the ordinary Portland cement, and/or the microfine ordinary Portland cement, may comprise lime and silica present in an amount of at least 50 wt %, at least 60 wt %, at least 70 wt %, at least 80 wt %, at least 90 wt %, etc.

In various embodiments, the ground granulated blast-furnace slag may comprise CaO, SiO₂, and/or MgO. In various embodiments, the microfine ground granulated blast-furnace slag may comprise CaO, SiO₂, and/or MgO.

In various embodiments, the ground granulated blast-furnace slag, and/or the microfine ground granulated blast-furnace slag, may comprise CaO present in an amount ranging from 30 to 50 wt %, 30 to 40 wt %, 40 to 50 wt %, etc. In various embodiments, the ground granulated blast-furnace slag, and/or the microfine ground granulated blast-furnace slag, may comprise SiO₂ present in an amount ranging from 28 to 38 wt %, 28 to 35 wt %, 28 to 30 wt %, 30 to 38 wt %, 35 to 38 wt %, etc. In various embodiments, the ground granulated blast-furnace slag, and/or the microfine ground granulated blast-furnace slag, may comprise MgO present in an amount from 1 to 18 wt %, 5 to 18 wt %, 10 to 18 wt %, 15 to 18 wt %, 1 to 5 wt %, 5 to 10 wt %, 10 to 15 wt %, etc.

In various embodiments, the ground granulated blast-furnace slag, and/or the microfine ground granulated blast-furnace slag, may comprise Al₂O₃, wherein the Al₂O₃ may be present in an amount ranging from 8 to 24 wt %, 10 to 24 wt %, 15 to 24 wt %, 20 to 24 wt %, 8 to 10 wt %, 8 to 15 wt %, 8 to 20 wt %, 10 to 20 wt %, etc.

In various embodiments, the bottom ash may comprise bottom ash from any power plant and/or any incineration facility. Bottom ash herein refers to a form of ash (i.e. non-combustible residue) produced from any power plant and/or any incineration facility. The power plant may comprise Municipal Solid Waste (MSW) incineration power plant, electricity-generation power plant, coal power plant, biomass power plant, etc. The incineration facility may comprise MSW incinerator, etc. In various embodiments, the bottom ash may be an incineration bottom ash.

In various embodiments, the bottom ash may comprise a heavy metal, a halide, and/or a volatile organic compound.

In various embodiments, the ordinary Portland cement may comprise microfine ordinary Portland cement, or the ground granulated blast-furnace slag may comprise microfine ground granulated blast-furnace slag, or the ordinary Portland cement may comprise microfine ordinary Portland cement and the ground granulated blast-furnace slag may comprise microfine ground granulated blast-furnace slag.

In various embodiments, the microfine ordinary Portland cement has a specific surface area of 750 m²/kg or higher, 800 m²/kg or higher, 850 m²/kg or higher, 900 m²/kg or higher, 950 m²/kg or higher, etc. In various embodiments, the microfine ground granulated blast-furnace slag has a specific surface area of 750 m²/kg or higher, 800 m²/kg or higher, 850 m²/kg or higher, 900 m²/kg or higher, 950 m²/kg or higher, etc.

The term “microfine” in the context of the present disclosure refers to a material having a specific surface area of 750 m²/kg or higher. A higher specific surface area understandably refers to a material that is finer. An ultrafine and nanofine material may have a specific surface area of 1,000 m²/kg or higher. Ultrafine and nanofine materials are finer (i.e. have a higher specific surface area than microfine materials). The terms “ultrafine” and “nanofine”, in the context of the present disclosure, differ in that “ultrafine” refers to a particle that may have a size larger than 0.5 μm while “nanofine” refers to a particle that may have a size below 100 nm. In other words, an ultrafine particle may have a size larger than 0.5 μm and a specific surface area of 1,000 m²/kg or higher, and a nanofine particle may have a size below 100 nm and a specific surface area of 1,000 m²/kg or higher. In various instances, the ordinary Portland cement, the microfine ordinary Portland cement, the ground granulated blast-furnace slag, and the microfine ground granulated blast-furnace slag, may include their ultrafine and/or nanofine versions.

In various embodiments, the specific surface area of ordinary Portland cement may range, for example, from 315 m²/kg to 375 m²/kg, 315 m²/kg to 345 m²/kg, etc. In various embodiments, the specific surface area of ground granulated blast-furnace slag may range from 420 to 460 m²/kg. Comparatively, as mentioned above, the specific surface area of microfine ordinary Portland cement and microfine ground granulated blast-furnace slag may be 750 m²/kg or higher.

In various embodiments, the aggregate may comprise at least about 40 wt % of the ordinary Portland cement (and/or microfine ordinary Portland cement). In various embodiments, the aggregate may comprise at least about 10 wt % of the ground granulated blast-furnace slag (and/or microfine ground granulated blast-furnace slag).

In various embodiments, the calcium silicate hydrate or derivative thereof encapsulating the bottom ash may have an average thickness ranging from 200 μm to 700 μm, 300 μm to 700 μm, 400 μm to 700 μm, 500 μm to 700 μm, 600 μm to 700, etc. In certain non-limiting examples, the calcium silicate hydrate may have an average thickness of about 448 μm or about 319 μm.

In various embodiments, the aggregate may have an average diameter of 0.8 mm or more, 0.9 mm or more, 1 mm or more. The term “diameter” and “size” are used interchangeably herein. The diameter is measured from one point at the periphery of the aggregate to another point at the periphery via a straight line through the center of the aggregate.

In various embodiments, the aggregate may further comprise an additive. The additive may comprise bentonite, clay, carbon nanofiber, biochar, fly ash, and/or silica fume. As mentioned above, the aggregate of the present disclosure may include one or more additives. Other than bentonite and silica fume, other additives may be included. Some examples of the other additives are described above. In one example, addition of 2 wt % to 5 wt % bentonite to the microfine GGBS-OPC mix demonstrated positive results of encapsulation of the IBA, wherein the wt % is based on the GGBS and OPC. GGBS content of around 50-60% may also demonstrate better results of encapsulation, wherein the wt % is based on the GGBS and OPC.

The binder solution with higher viscosity showed better encapsulation due to improved adhesion of the binder solution coat to the IBA. However, if the binder solution is too viscous, spreading of the GGBS-OPC mixture to coat on the IBA may be difficult.

The aggregate as described above may be a core-shell aggregate in various embodiments. The shell may include the hydraulic cement and the ground granulated blast-furnace slag. The shell may include the calcium silicate hydrate or derivative thereof. The hydraulic cement and the ground granulated blast-furnace slag may include the calcium silicate hydrate or derivative thereof. The cement may be hydrated in the presence of the ground granulated blast-furnace slag to have the calcium silicate hydrate or derivative formed. The cement may be converted entirely or substantially into calcium silicate hydrate or a derivative thereof in the presence of the ground granulated blast-furnace slag. Said differently, the hydraulic cement, the ground granulated blast-furnace slag, and/or calcium silicate hydrate, may form the shell encapsulating the core. The core may include the bottom ash. The hydraulic cement and the ground granulated blast-furnace slag may include the calcium silicate hydrate or derivative thereof which encapsulate the bottom ash. The hydraulic cement may be or may include microfine ordinary Portland cement. The ground granulated blast-furnace slag may be or may include microfine ground granulated blast-furnace slag.

The present disclosure also relates to a method of producing the aggregate. Embodiments and advantages described for the present aggregate in various embodiments of the first aspect can be analogously valid for the present method subsequently described herein, and vice versa. Where the various embodiments and advantages have already been described above and examples demonstrated herein, they shall not be iterated for brevity.

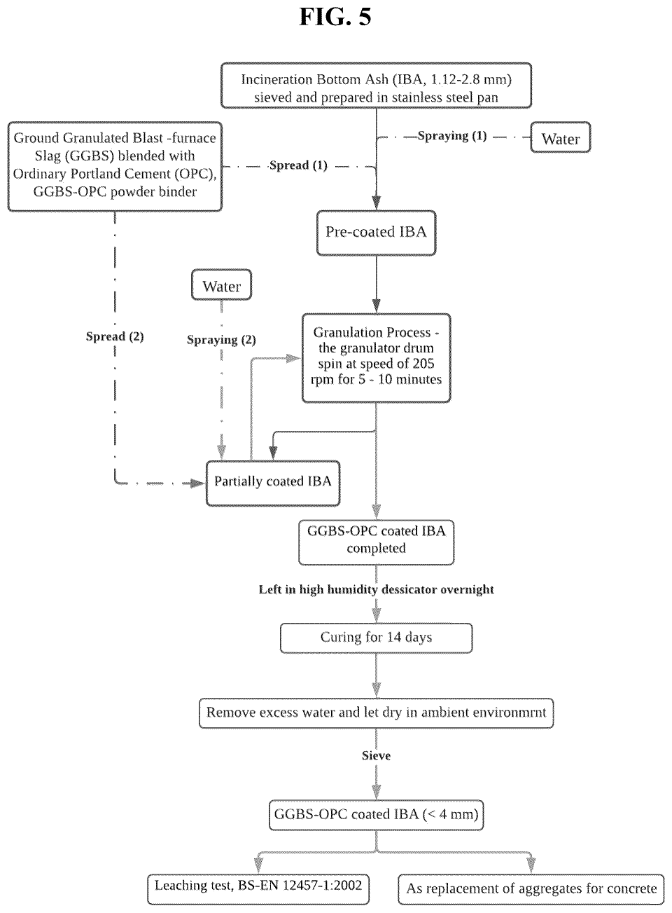

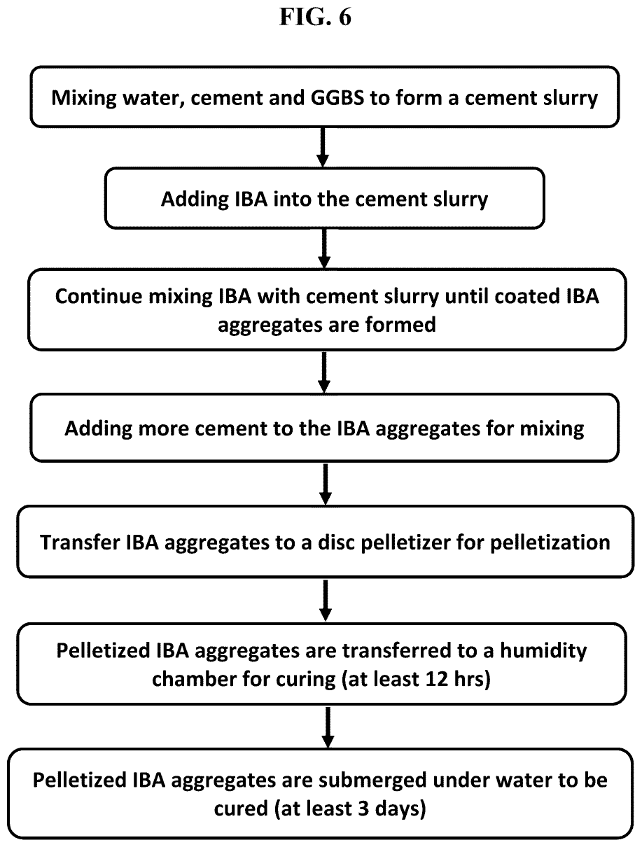

The method of producing the aggregate may comprise mixing the cement and the ground granulated blast-furnace slag with the bottom ash in the presence of water to form pre-coated bottom ash, and granulating the pre-coated bottom ash. Two non-limiting embodiments of the present method are illustrated in FIGS. 5 and 6.

In various embodiments, prior to mixing the cement and the ground granulated blast-furnace slag with the bottom ash, the bottom ash may undergo a size reduction step, such as grinding to reduce the original size of raw bottom ash.

In certain non-limiting embodiments, the method may further comprise contacting a bottom ash with water prior to mixing the cement and the ground granulated blast-furnace slag with the bottom ash (such non-limiting embodiments are illustrated through FIG. 5). Contacting the bottom ash with water may comprise spraying the bottom ash with water.

In certain non-limiting embodiments, granulating the pre-coated bottom ash may be carried out for a duration of at least 3 minutes. In certain non-limiting embodiments, granulating the pre-coated bottom ash may be carried out for a duration of at least 3 minutes, and wherein granulating the pre-coated bottom ash may comprise granulating the pre-coated bottom ash in a granulator drum rotating at a speed of at least 100 rotation per minute (rpm).

In certain non-limiting embodiments, the method may further comprise mixing the cement and the ground granulated blast-furnace slag with water to form a slurry prior to mixing the cement and the ground granulated blast-furnace slag with the bottom ash (such embodiments are illustrated via FIG. 6). In such non-limiting instances, granulating the pre-coated bottom ash may comprise adding more cement to the pre-coated bottom ash. In such non-limiting instances, the method may further comprise pelletizing the pre-coated bottom ash after granulating the pre-coated bottom ash. Pelletization of the pre-coated bottom ash may be carried out in a disc pelletizer.

In certain non-limiting embodiments, the ordinary Portland cement (and/or the microfine ordinary Portland cement) and the ground granulated blast-furnace slag (and/or the microfine ground granulated blast-furnace slag) can be in the form of a liquid binder (e.g. at the start of mixing or during mixing) so as to assist in the immobilization of heavy metals through the following mechanism: (i) the use of microfine slag can harden grout that has low permeability, acting as a diffusion barrier, (ii) the use of microfine slag can increase C—S—H (calcium silicate hydrate) as C—S—H has high surface area which enables adsorption of ions into its crystal structure, and (iii) faster curing time vis-a-vis Slag.

In various embodiments, the method may further comprise curing the aggregate. Curing the aggregate may comprise thermal treating the aggregate in a humidity chamber, and conditioning the aggregate in water.

In various embodiments, curing the aggregate may further comprise steaming the aggregate in the humidity chamber.

As mentioned above, the method may include curing the aggregate. Curing the aggregate may comprise of a thermal treatment of the aggregate in a humidity chamber and steam curing of the aggregate. Thermal treatment and steam curing of the aggregate in the chamber help to strengthen the binding agent (e.g. the GGBS and OPC) in the aggregate, that is to say, the shell of the aggregate becomes more cohesive. When the shell becomes more cohesive, it can be more tightly packed and gain mechanical strength to confine (prevent leaching) the bottom ash within the shell.

The thermal treatment may include heating the aggregate in a humidity chamber. The humidity in the humidity chamber may be at least 85%, 90%, etc. The thermal treatment can be carried out for at least 12 hours, 24 hours, etc. The thermal treatment also helps to reduce duration of conditioning the aggregate in water from 28 days to 14 days or less.

The steam curing may involve passing steam into a steam curing chamber under atmospheric pressure. The steam curing can be carried out for at least an hour. The steam curing also helps to reduce duration of conditioning the aggregate in water from 28 days to 7 days or less.

Pursuant to the steps described above, the treated aggregate may be placed in a water bath containing water as a final step of the curing process. The aggregate may be placed in water for at least 3 days.

Sufficient time may be given for the binder coat to cure for 1 day, 3 days, 7 days and 28 days. Accelerated curing can be relied on by placing the coated IBA into water bath with temperature of 40° C. for 2 days.

In summary, the present aggregate and method involve the encapsulation as mentioned above. Although ordinary Portland cement and ground granulated blast-furnace slag may be commercially available, this is not the case for microfine ordinary Portland cement and microfine ground granulated blast-furnace slag. In various non-limiting embodiments of the present disclosure, where microfine OPC and microfine GGBS are used, the microfine ground granulated blast-furnace slag and microfine ordinary Portland cement are produced for forming the present aggregate. The ample availability of starting raw materials renders the production of microfine ordinary Portland cement and microfine ground granulated blast-furnace slag, and hence the present aggregate and method, economically viable. Coupled with the present powder coating mixture (e.g. GGBS-OPC) and granulation process to have the bottom ash encapsulated, the present aggregate and method advantageously fulfil stringent leaching requirements. Herein, the combination of ordinary Portland cement and ground granulated blast-furnace slag for encapsulating bottom ash does not lead to undesirable agglomeration of encapsulated IBA to form a concrete or slag without an aggregate. Comparatively, traditional encapsulation methods tend not to develop aggregates of the size and advantages achieved herein using traditional materials. The desired encapsulation result is achieved by utilizing the present powder coating mixture (e.g. GGBS-OPC) and granulation process/methodology.

The word “substantially” may refer to a component present in an amount of at least 70 wt %, 75 wt %, 80 wt %, 85 wt %, 90 wt %, 95 wt %, 98 wt %, 99 wt %, 99.5 wt %, 99.9 wt %, etc. of a composite. Where necessary, the word “substantially” may be omitted from the definition of the present disclosure.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Unless specified otherwise, the terms “comprising” and “comprise”, and grammatical variants thereof, are intended to represent “open” or “inclusive” language such that they include recited elements but also permit inclusion of additional, unrecited elements.

### EXAMPLES

The present disclosure relates to an aggregate, its method of production and uses.

The present aggregate contains a bottom ash, such as an incineration bottom ash (IBA). The bottom ash can be chemically treated or not chemically treated. The method of producing the present aggregate may involve a straightforward processing of the bottom ash to form the aggregate, wherein advantageously the bottom ash need not be chemically treated prior to the bottom ash's use.

The present method is able to meet the requirements of British Standard Institute for disposal waste to landfill, e.g. BS EN 12457-1:2002 (Characterisation of waste. Leaching. Compliance test for leaching of granular waste materials and sludges. One stage batch test at a liquid to solid ratio of 2 L/kg for materials with high solid content and with particle size below 4 mm (without or with size reduction), STANDARD by British-Adopted European Standard). It follows that the present aggregate formed from the present method meets the same requirements given the present method fulfils such standards.

Further advantageously, the present aggregate and method are economically viable as it is based on the use of materials that are readily available. This reduces the risk of involving untested materials that complicates reliability of the present aggregate and method.

The present aggregate, its method of production and uses, are described in further details, by way of non-limiting examples, as set forth below.

### Example 1: Introductory Discussion of Aggregate and Method

The method of the present disclosure has been developed based on a granulation process (i.e. involving a granluation step) that involves a mix of ground granulated blast-furnace slag and ordinary Portland cement (also termed herein as “ground granulated blast-furnace slag-ordinary-Portland cement (GGBS-OPC)”) to produce coated incineration bottom ash that can be used at least as aggregates, e.g. concrete aggregates. As the present method involves coating of incineration bottom ash, the present method is termed herein a “coating method”. The present method, and the aggregate, are feasibly workable with any bottom ashes generated by power plants, such as municipal solid waste (MWS) incineration power plants, coal power plants, biomass power plants, and/or any other power plants.

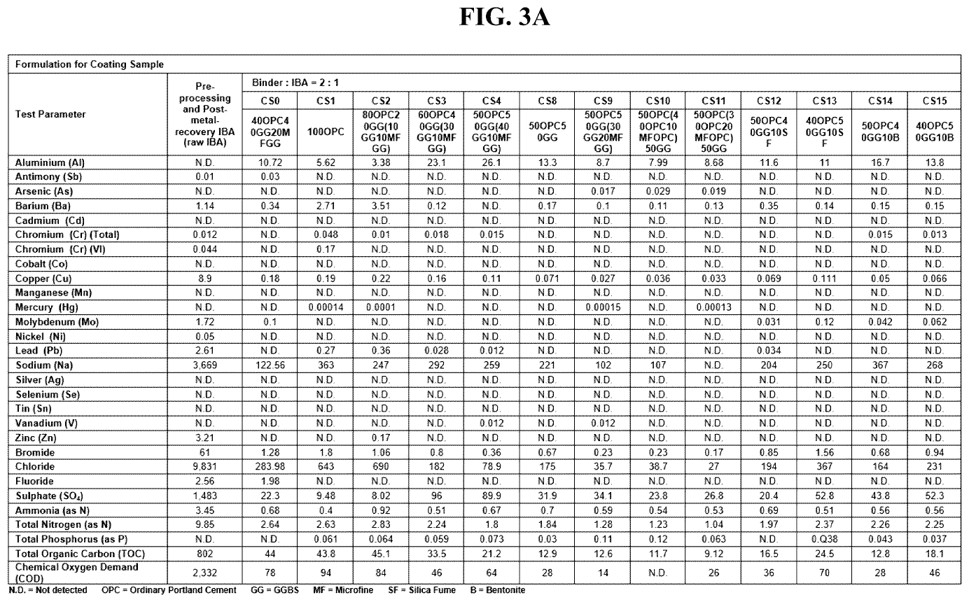

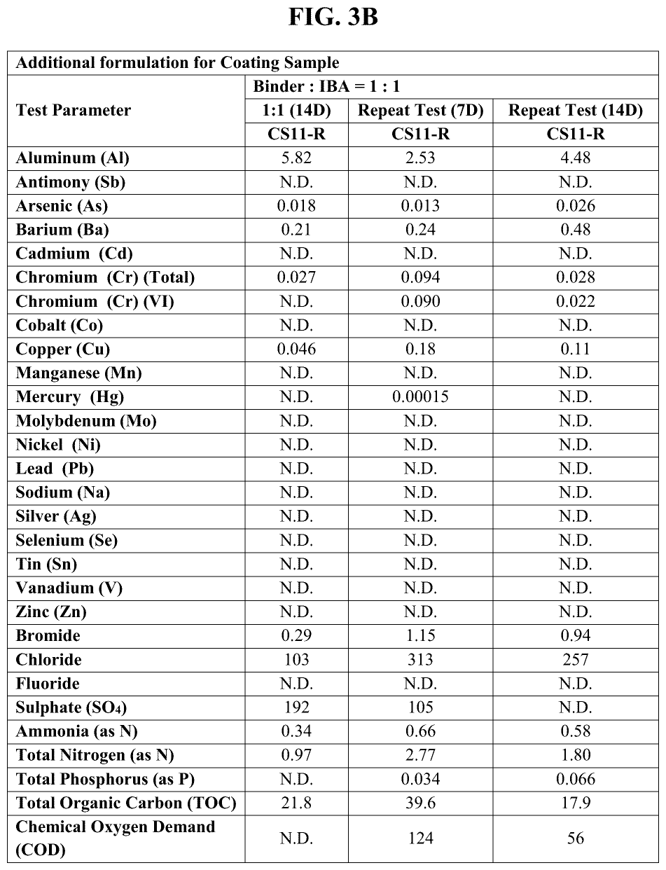

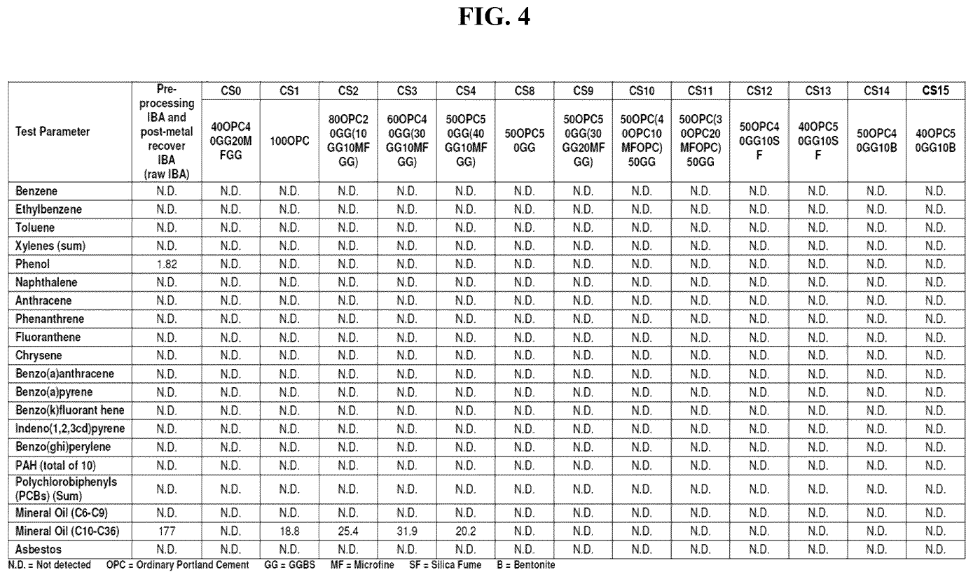

At least 13 formulations were tested. The formulations tested include GGBS-OPC powder (also termed herein a powder binder), which can comprise a mixture of OPC and GGBS, wherein the OPC and GGBS can range from 40 weight percent to 100 weight percent (wt %) and 10 to 50 wt % (or even 10 to 60 wt %), respectively. That is to say, in one of the samples tested (see CS1 in FIG. 3A and 4), no GGBS was used, i.e only 100 wt % OPC was used for the powder. The wt % is based on the GGBS and OPC mixture. The powder forms a coating that encapsulates the incineration bottom ash, forming IBA aggregates. The coating, which encapsulates incineration bottom ash, prevents leaching of heavy metals and toxic substances from the encapsulated incineration bottom ash.

The OPC and GGBS can be or can include microfine OPC (MFOPC) and microfine GGBS, respectively. That is to say, the microfine OPC and microfine GGBS can range from 40% to 100 wt % and 10 to 50 wt % (or even 10 to 60 wt %), respectively, wherein the wt % is based on the GGBS and OPC mixture.

Among the formulations tested, one formulation involving ordinary Portland cement, microfine ordinary Portland cement and ground granulated blast-furnace, denoted herein as “OPC:MFOPC:GGBS” (referred to as CS11 for brevity), was observed to be the most desirable (albeit the other formulations are workable). This is because CS11 demonstrated the least leaching, i.c. the lowest amount of heavy metals and toxic substances detected as compared to raw IBA. It was discovered that the CS11 formulation can significantly reduce chloride leaching, i.e. from 9800 mg/kg for raw IBA to 27 mg/kg. This achievement appears not attainable by traditional coating methods. From the formulations tested, the powder coating (which include OPC and GGBS, even if microfine OPC and GGBS are used) can effectively confine and immobilize toxic heavy metals present in the IBA. To be more precise, core-shell aggregates are produced using the present method that involves the granulation. Each of the core-shell aggregate, i.e. the present aggregate, has a shell formed from the powder coating (OPC, GGBS, and/or their microfine versions) encapsulating the IBA in the core. It was also observed that the GGBS-OPC coated IBA aggregates may be utilized even as a suitable replacement for fine aggregates in producing ready-mixed concrete. Based on all formulations tested, the resultant aggregates are all successfully composed of coated IBA, wherein the formulation of GGBS-OPC acts as a powder binder that coats on IBA and prevents the leaching of toxic heavy metal from IBA. As such, GGBS-OPC coated IBA aggregates can be used as replacement aggregates for incorporation into a concrete matrix with no environmental concerns.

Using the granulation step as described in the present disclosure, production of the GGBS-OPC coated IBA can be scaled up and replicated into an industrial-scale operation for commercialisation. The formulated GGBS-OPC powder binder is robust (i.e. confers the shell and hence the aggregate a longer shelf-life and durability) and can be further configured to achieve more cost-savings for the resultant aggregate product and for the entire production processes from the use of raw materials to final products given the method is straightforward and absent of any chemical treatment of the IBA.

One or more examples of the present disclosure demonstrate a powder coating method involving granulation. Prior to the granulation, a grinding capability was also developed to aid production of the GGBS-OPC coated IBA particles (i.e. the present aggregates) of size ranging from about 0.8 mm to about 4 mm, about 2 mm to about 4 mm, etc. The GGBS-OPC coated IBA particles can be used as fine aggregates replacement in ready-mixed concrete. During the granulation, the IBA particles can be wetted together with the GGBS-OPC powder (which is able to act as a binder of IBA).

In more details, a powder coating method based on granulation was developed. Before the granulation, grinding capability (i.e. a grinding step) to produce IBA with an average particle size ranging from about 0.075 mm to about 6.3 mm was developed. In one example, the average size fraction of IBA used in the present method was about 1.12 mm to 2 mm. During the granulation, the particle sizes of the IBA particles increased due to coating of the GGBS-OPC powder binder onto the IBA particles. After granulation, the average particle size of a OPC-GGBS coated IBA aggregate is about 0.8 mm to about 4 mm, about 2 mm to about 4 mm. The selection of the GGBS-OPC coated IBA size at this range helps achieve in meeting an international leaching test requirement, (i.e. EN12457-1:2002, the compliance test leaching of granular waste materials and sludge. One stage batch test at a liquid to solid ratio of 2 L/kg for materials with high solid content and particle size below 4 mm (without or with size reduction)). As such, the resultant GGBS-OPC coated IBA particles have tremendous potential to be used as fine aggregates replacement in ready-mixed concrete industries. The resultant aggregates may have an average diameter of 25 mm, 20 mm, etc. The resultant aggregates may have an average diameter of 0.8 mm or more. The granulation involves forming a layer of coating on the IBA particles (e.g. on each of the IBA particles). The layer of coating confines the heavy metals and any toxic materials therein (i.e. prevent leaching even when the resultant aggregate is used in a harsh environment). The layer of coating can be deemed as a shell encapsulating one or more of the IBA particles. The granulation may comprise, as non-limiting examples, any one of agglomerating, pelletizing, briquetting, spray dry agglomeration. In spray dry agglomeration, a slurry may be sprayed into a column containing the particles. The slurry may contain the materials (such as OPC, GGBS, and/or their microfine versions) for forming the layer of coating and the particles may contain the IBA particles. The granulation may be carried out using a drum granulator, a tumbling (pan) granulator, or a mix granulator. The mix granulator involves a combination of the drum and tumbling granulator.

The confinement and/or immobilization of heavy metals within the core of the aggregate can be achieved through one or more of the following: (1) high alkalinity of the binder mixture (i.e. GGBS-OPC mixture) which reduces the leaching of heavy metals entirely or substantially, (2) a calcium silicate hydrate (C—S—H) gel has a high surface area which enables adsorption of heavy metal ions-a slag blended cement mixture produces a higher proportion of C—S—H which increases the sorption capacity. and/or (3) the low permeability of the hardened shell acts as a diffusion barrier against heavy metal leaching.

The C—S—H gel mentioned above may arise during formation of the GGBS-OPC coating, for example, when a slag (GGBS) is blended with a cement (e.g. OPC). The cement (e.g. OPC) is hydrated in the presence of the GGBS to have the calcium silicate hydrate or derivative thereof formed in the shell (i.e. encapsulation layer). At early stages of forming the encapsulation layer, the calcium silicate hydrate (or derivative thereof) may exist in the gel form. In other words, the C—S—H gel may form in the shell at early stages of forming the encapsulation layer around the IBA. However, the C—S—H gel hardens into a solid as the C—S—H gel cures. Hence, in the resultant aggregate, the C—S—H gel forms into a solid calcium silicate hydrate layer. The calcium silicate hydrate layer can be present in the shell. In certain non-limiting instances, the calcium silicate hydrate layer can form in the shell periphery and away from the IBA core. In such non-limiting instances, the C—S—H then serves as an additional coating of encapsulation, in addition to the GGBS-OPC coating the IBA. In such non-limiting instances, the C—S—H layer may form peripheral to the GGBS-OPC layer. Also, the GGBS-OPC can be completely converted into C—S—H in certain non-limiting instances, then the C—S—H serves as the sole encapsulation layer of the IBA core.

In addition to the GGBS-OPC and C—S—H, the concrete matrix in which the aggregates are incorporated when the aggregates are utilized as concrete aggregates renders a “dual defence” encapsulation to impede and/or prevent the leaching of heavy metal for use in the concrete applications. Said differently, when GGBS-OPC coated IBA is used as an aggregate replacement in the general concrete making, the concrete can form another layer of protection external to the C—S—H and/or GGBS-OPC coated IBA, and this is referred hereinto as “dual defence”, i.e. the first defence refers to the encapsulation layer of C—S—H and/or GGBS-OPC coated on the IBA while the second defence refers to the concrete matrix in which the aggregate is incorporated. As can be understood from above, the granulation is straightforward for encapsulating IBA in GGBS-OPC and hence easily scaled-up into a cost-efficient and commercial-worthy granulation.

### Example 2: Advantages of Present Aggregate and Method Over Traditional Methods

The present method renders higher specific gravity and stronger compressive strength of the present IBA aggregates. Traditionally, alkali-activated materials as liquid binders may be used for the granulation process of IBA aggregates. However, such traditional approaches tend to suffer from certain limitations, such as higher operation cost, use of chemicals and being ineffective in immobilising the heavy metals. In contrast, the present method involves GGBS blended with OPC to render a GGBS-OPC powder binder for the production of IBA aggregate through aforesaid granulation. The present method converts a waste such as IBA into a resource such as an aggregate useful in concrete materials, hence the present aggregate may be termed herein a “waste-to-resource” aggregate. Other than IBA being a waste, the GGBS was also derived from a waste material. In the present method, the GGBS was produced in-house by grinding granulated blast-furnace slag (an industrial by-product of the steel mills' pig iron production in blast furnaces, wherein pig iron refers to crude iron). Being a by-product, the granulated blast-furnace slag tends to be unwanted and hence becomes easily available. As such, the granulated blast-furnace slag is abundant and it follows that GGBS is abundantly available and understandably a cost-effective material (relative to OPC).

In certain non-limiting instances, a high-shear granulation process may be preferred as it may allow spreading of viscous liquids, processing the viscous material, and producing more compact and spherical granules than low-shear granulation process. In general, the granulation can commence with the addition of pre-coated IBA, for example, into a granulation drum. During the granulation, the IBA particles are wetted with water and mixed with the GGBS-OPC powder binder, followed by colliding and sticking together as part of a particle enlargement process. Also, the hydration of the GGBS-OPC powder binder gives rise to a liquid binder which renders formation of calcium silicate hydrate (C—S—H) gel (or a derivative thereof) on the IBA particle's surface. The IBA particles get incorporated in the C—S—H matrix's crystal structure when the C—S—H gel hardens (becomes cured), resulting in a rigid mass with improved physical and chemical properties. It is expected that the C—S—H gel layer formed at the start from hydration of the OPC in the presence of GGBS and water, which hardens into a solid, can serve as a first or primary encapsulation layer of protection against potential leaching of heavy metals. From there, the resultant coated IBA may be used as an aggregate in a concrete. In other words, the coated IBA as an aggregate is encapsulated in the matrix of concrete, wherein the concrete acts as a second layer that encapsulates the IBA. As such, due to the unique advantage of the present method to immobilize the heavy metals via the C—S—H matrix produced during the encapsulation process and given the advantage of having the encapsulated aggregates eventually used as aggregates within a concrete matrix, the present aggregate and method afford an opportunity to utilize solid waste IBA as inert coarse or fine aggregate in concrete. Said differently, the concrete matrix act as a secondary encapsulation layer of defence to mitigate potential leaching of toxic heavy metals. This two-fold encapsulation arising from the C—S—H matrix (and/or even the GGBS-OPC) and having the coated IBA aggregate bound within a ready-mixed concrete, confers the resultant IBA aggregates with a “dual defence” that prevents and/or mitigates the leaching of heavy metal and toxic contents from a concrete.

### Example 3: Technical Discussion of the Present Aggregate and Method

An outline of the present aggregate and method is that the waste-to-resource IBA aggregates are produced from blending GGBS with OPC to form a GGBS-OPC powder binder for encapsulating the IBA through granulation. Core-shell granules formed were then explored for use as GGBS-OPC coated IBA green aggregates.

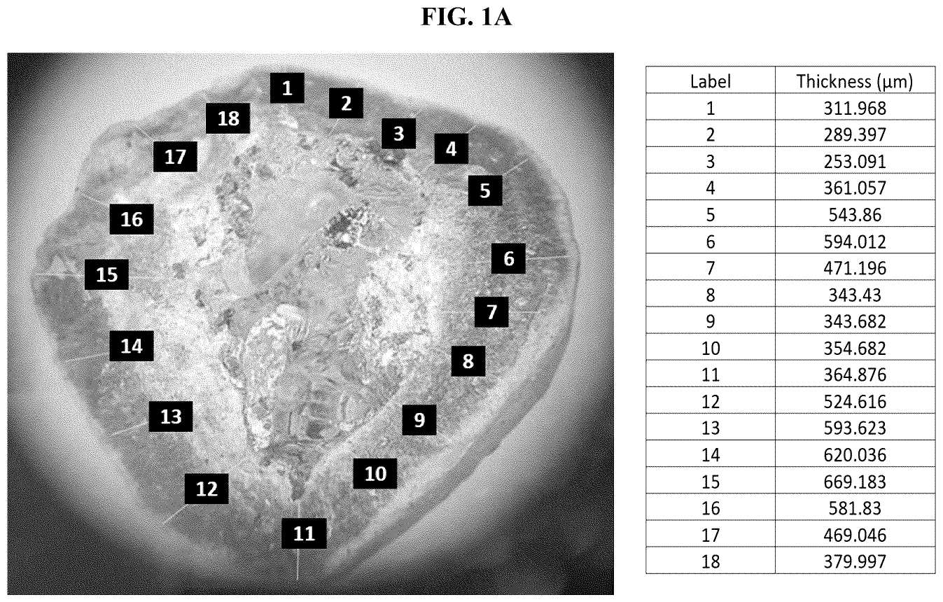

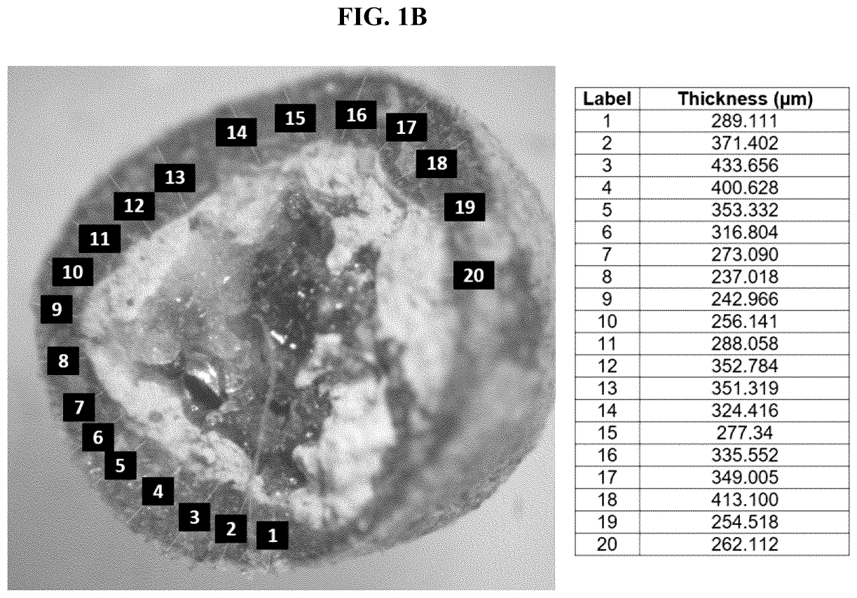

Particularly, the present aggregate and method may involve hydration of the GGBS-OPC, which forms calcium silicate hydrate (C—S—H) in a gel phase during the process, which in turn converts to a crystalline phase in the resultant aggregate. In addition, GGBS can reduce the pore structure (i.e. reduce porosity) of OPC and decrease toxic metal diffusion out from the shell. Thus, GGBS-OPC powder binder enhances the formation of C—S—H gel (and hence the solid C—S—H encapsulation layer) on the surface of IBA particles during granulation. The immobilization can also be attributed to sorption of ions by forming C—S—H, precipitation of insoluble hydroxide, and lattice incorporation into crystalline components in GGBS-OPC matrix (e.g. sec FIG. 1).

The granulation can be carried out using steps of (1) spraying of water on IBA particles, (2) pre-coating the IBA with the formulation of GGBS-OPC powder binder, (3) feeding the pre-coated IBA into a granulator drum, (4) having the granulation commenced at normal speed for certain minutes (e.g. granulation for at least 3 mins in a granulator rotating drum at a speed of at least 100 rpm), (5) repeat the steps of spraying water and adding of the GGBS-OPC powder binder to granule IBA during the granulation until all the weighted GGBS-OPC powder binder amalgamate with the IBA, (6) GGBS-OPC coated IBA are dried, for example in a humidity chamber providing an environment of at least 85% humidity for a minimum of 12 hours (e.g. 24 hours) with at least 25° C., (7) having the GGBS-OPC coated IBA continue curing for 14 days, and (8) sieving and grading of the produced GGBS-OPC coated IBA aggregates.

The produced green IBA aggregates were then subjected to a leaching test, following BS EN 12457-1, which is one stage batch test at a liquid to solid ratio of 10 L/kg. The pH of the obtained leaching solutions was measured using a pH meter. An ionic chromatography (IC) was used to identify and determine the anions in the leaching solution, and the cations in the leaching solution were identified and determined by an inductively coupled plasma (ICP) spectrometer. A total organic carbon (TOC) analyser was used to determine the total organic carbon content of leaching solution. Total dissolved solids (TDS) and dissolved organic carbon (DOC) of leaching solution were also measured.

FIG. 3A, 3B and 4 present the batch leaching test results EN12457-1:2002, and volatile organic composition leaching test for GGBS-OPC coated IBA with varying formulations (e.g. see FIG. 3A and 3B). Leaching of chromium (VI) denoted as (Cr), copper (Cu), molybdenum (Mo), nickel (Ni), lead (Pb), sodium (Na), zinc (Zn), bromide, chloride, sulphate (SO₄), ammonia, total nitrogen and total organic carbon (TOC) significantly exceeds the limit values for raw IBA sample (denoted herein R1). Besides, leaching of phenols and mineral oils (C10-C36) were detected as well. Heavy metals tend to cause more concerns than volatile organic compounds due to their higher leaching and contamination potential. Therefore, the heavy metals (in FIG. 3) are focused further in this study. The results showed that the heavy metals such as Cr, Mo, Ni and Zn for GGBS-OPC coated IBA (CS0 and from CS2 to CS12) was successfully immobilised in the matrix of GGBS-OPC because the heavy metals were either not detected or below the limit values in the leaching solution. Additionally, Cu's heavy metal was significantly reduced and below the limit values in leaching as compared to raw IBA, for example, in samples CS9, CS10, CS11 and CS14. Leaching of Pb is not detected for all the GGBS-OPC coated IBA samples except for samples CS1, CS2, CS3 and S12 which are 0.27 mg/kg, 0.36 mg/kg, 0.028 mg/kg and 0.034 mg/kg, respectively, as compared to limit values of 0.02 mg/kg. This may be attributed to the Pb not fully encapsulated in calcium silicate hydrate or GGBS-OPC matrix. Ettringite is found to have strong fixing with heavy metal like Pb, which are strongly encapsulated into calcium silicate matrix by replacing Ca in GGBS-OPC. However, ettringite from OPC (CS1) or GGBS-OPC (CS2 and CS3) is not significantly improved for the leaching of Pb. Metal specific factors may significantly impact their mobility, such as redox potential on Cr, organic ligands in the case of Cu, and mineral precipitation and sorption kinetics on Pb. Therefore, the leaching of one or more of the metals of Cr, Cu and Pb may be detected. The GGBS-OPC coated IBA showed Al detected in the leaching test. However, the leaching of Al is not from IBA as no Al was detected in raw IBA. Hence, the leaching of Al detected is neither a concern nor a relevant indicator of leaching in the present context. Rather, the Al may have been from GGBS and OPC which contain Al₂O₃ in their chemical composition.

From the results, comparing with the original raw IBA, the leaching of sodium (Na), chloride, bromide, sulphate and ammonia were reduced by over a factor of about 20, 250, 300, 70, and 7, respectively. Besides, for all GGBS-OPC coated IBA aggregate samples, leaching of Na, SO₄ and ammonia were below the limit values at acceptable levels. The possibility of using GGBS-OPC powder binder to coat IBA is observably advantageous. The GGBS-OPC matrix's efficiency has been demonstrated to be able to immobilize Na, SO₄ and ammonia leaching from IBA. Samples CS9, CS10, and CS11 demonstrated the most desirable results among all the GGBS-OPC coated IBA aggregate samples based on below limit values of chloride (below 40 mg/kg) detected. From the results, it is evident that the GGBS-OPC matrix had outstandingly succeeded in reducing chloride leaching from IBA. Although vanadium and bromide were detected in CS9 and CS11, the values are negligible as they were very close to limit values and the instrument's detection limit. The microfine ordinary Portland Cement (MFOPC) have a high specific surface area, e.g. about more than 800 m²/kg (±5%) as compared to Ordinary Portland Cement (OPC), e.g. about 331 m²/kg (±5%). The findings indicated that the high specific surface area likely enhanced entrapment efficacy due to its effectiveness to immobilize the toxic metals and prevent the toxic metals from leaching out of IBA. To demonstrate this, samples CS10 and CS11 were formulated, which showed a promising opportunity to beneficiate IBA as a raw materials as partial replacement of fine aggregates for use in concrete plus the benefit of being able to make best use of IBA, which is a global challenge. The transformation from waste to fine aggregate replacement to derive manufacturing costs savings (e.g. circumvent high usage of water and high energy cost required in traditional methods), enables countries using the present aggregate and method to gain a great environmental benefit.

### Example 4: Commercial and Potential Applications

The aggregate of the present disclosure is derived from waste materials as mentioned above, particularly IBA, and hence may be termed herein a “green” IBA aggregate.

The aggregate is produced by encapsulation of a formulated GGBS-OPC powder binder on IBA through granulation. The present aggregate and method can be scaled up and is economically viable for commercialisation. Through the present aggregate and method, solid waste IBA can be deployed as green aggregates for application in ready-mixed and pre-cast concrete. The global consumption of construction aggregates may reach 62.9 billion metric tonnes by the end of 2024, up from 43.3 billion metric tonnes in 2016. As such, the value of construction aggregates is estimated to be between 3.2 and 3.8 billion tonnes over 2016 to 2024. The high demand for aggregates is mainly due to economic growth and increase of construction activity. The present aggregate and method considerably help reduce annual waste disposal handling volume in Singapore, which is about 500,000 to 600,000 tons of IBA per annum, significantly prolonging the lifespan of Semakau Landfill.

While the present disclosure has been particularly shown and described with reference to specific embodiments, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

1. An aggregate comprising:
a cement comprising ordinary Portland cement;
a ground granulated blast-furnace slag; and
bottom ash,
wherein the cement is hydrated in the presence of the ground granulated blast-furnace slag to have a calcium silicate hydrate or derivative thereof formed which encapsulates the bottom ash.

2. (canceled)

3. (canceled)

4. The aggregate of claim 1, wherein the ground granulated blast-furnace slag comprises CaO, SiO₂, and/or MgO.

5. The aggregate of claim 1, wherein the ground granulated blast-furnace slag comprises:
CaO present in an amount ranging from 30 to 50 wt %;
SiO₂ present in an amount ranging from 28 to 38 wt %; and
MgO present in an amount from 1 to 18 wt %.

6. (canceled)

7. The aggregate of claim 1, wherein the bottom ash comprises a heavy metal, a halide, and/or a volatile organic compound.

8. The aggregate of claim 1, wherein
the ordinary Portland cement comprises microfine ordinary Portland cement; or the ground granulated blast-furnace slag comprises microfine ground granulated blast-furnace slag; or
the ordinary Portland cement comprises microfine ordinary Portland cement and the ground granulated blast-furnace slag comprises microfine ground granulated blast-furnace slag.

9. The aggregate of claim 8, wherein the microfine ordinary Portland cement has a specific surface area of 750 m²/kg or higher.

10. The aggregate of claim 8, wherein the microfine ground granulated blast-furnace slag has a specific surface area of 750 m²/kg or higher.

11. The aggregate of claim 1, wherein the aggregate comprises at least about 40 wt % of the ordinary Portland cement.

12. The aggregate of the claim 1, wherein the aggregate comprises at least about 10 wt % of the ground granulated blast-furnace slag.

13. The aggregate of claim 1, wherein the calcium silicate hydrate or derivative thereof encapsulating the bottom ash has an average thickness ranging from 200 μm to 700 μm.

14. The aggregate of claim 1, wherein the aggregate has an average diameter of 0.8 mm or more.

15. The aggregate of claim 1, wherein the aggregate further comprises an additive, wherein the additive comprises bentonite, clay, carbon nanofiber, biochar, fly ash, and/or silica fume.

16. A method of producing the aggregate of claim 1, the method comprising:
mixing the cement and the ground granulated blast-furnace slag with the bottom ash in the presence of water to form pre-coated bottom ash; and
granulating the pre-coated bottom ash.

17. The method of claim 16, further comprising:
contacting a bottom ash with water prior to mixing the cement and the ground granulated blast-furnace slag with the bottom ash; or contacting a bottom ash with water prior to mixing the cement and the ground granulated blast-furnace slag with the bottom ash, wherein contacting the bottom ash with water comprises spraying the bottom ash with water.

18. The method of claim 16,
wherein granulating the pre-coated bottom ash is carried out for a duration of at least 3 minutes; or
wherein granulating the pre-coated bottom ash is carried out for a duration of at least 3 minutes, and wherein granulating the pre-coated bottom ash comprises granulating the pre-coated bottom ash in a granulator drum rotating at a speed of at least 100 rpm.

19. The method of claim 16, further comprising mixing the cement and the ground granulated blast-furnace slag with water to form a slurry prior to mixing the cement and the ground granulated blast-furnace slag with the bottom ash.

20. The method of claim 19, wherein granulating the pre-coated bottom ash comprises adding more cement to the pre-coated bottom ash.

21. The method of claim 19, further comprising pelletizing the pre-coated bottom ash after granulating the pre-coated bottom ash.

22. The method of claim 16, further comprises curing the aggregate, wherein curing the aggregate comprises:
thermal treating the aggregate in a humidity chamber; and
conditioning the aggregate in water.

23. The method of claim 22, wherein curing the aggregate further comprises steaming the aggregate in the humidity chamber.
